(19) United States
(12) Patent Application Publication
(10) Pub. No.: US 2007/0164466 A1
(43) Pub. Date: Jul. 19, 2007

(54) Method for producing filler-containing foam slabs

(76) Inventors: Dietrich Scherzer, Neustadt (DE); Rudiger Bluhm, Limburgerhof (DE); Franz-Josef Dietzen, Habloch (DE); Swen Ruck, Worms (DE)

Correspondence Address: CONNOLLY BOVE LODGE & HUTZ LLP, P.O. BOX 2207, WILMINGTON, DE, 19899-2207, US

(21) Appl. No.: 10/589,617

(22) PCT Filed: Feb. 16, 2005
(86) PCT No.: PCT/EP05/01544

§ 371 Date: Aug. 16, 2006

(30) Foreign Application Priority Data
Feb. 18, 2004 (DE) 10 2004 008 201.4

(51) Int. Cl. B29C 44/20

(52) U.S. Cl. 264/45.9; 264/53

(57) ABSTRACT

Process for production of foam webs or foam sheets, these webs or sheets being based on a polymer selected from polysulfones, polyetherimides, polyether ketones, and styrene polymers, via extrusion of a melt which comprises the polymer and a blowing agent, and then foaming of this melt, which comprises a process in which the melt also comprises from 1 to 50% by weight, based on the polymer, of a filler selected from A) a fibrous filler A, B) a particulate, non-graphite filler B, and mixtures of these.

The invention relates to a process for production of foam webs or foam sheets, these webs or sheets being based on a polymer selected from polysulfones, polyetherimides, polyether ketones, and styrene polymers, via extrusion of a melt which comprises the polymer and a blowing agent, and then foaming of this melt,
which comprises a process in which the melt also comprises from 1 to 50% by weight, based on the polymer, of a filler selected from
A) a fibrous filler A,
B) a particulate, non-graphite filler B,
and mixtures of these.

The invention further relates to the foam webs or foam sheets obtainable by the process.

Foams composed of polymers are obtained by way of example via foaming of particles comprising blowing agent. By way of example, in what is known as the suspension process for production of EPS (expandable polystyrene), styrene in suspension is polymerized with concomitant use of a blowing agent, giving polystyrene particles comprising blowing agent. These can be foamed to give the finished foam (molded foam) by treating them with steam in closed molds, thus expanding the particles and fusing them to one another.

In the extrusion process for EPS production, the polymer is provided with a nucleating agent—which permits foaming and causes production of a fine-cell foam during expansion of the polymer comprising blowing agent—and then, with melting, is mixed in an extruder with a blowing agent which is added to the extruder. An underwater pelletizer operated at superatmospheric pressure is used for extrusion and pelletization of the melt comprising blowing agent, thus preventing it from foaming. The pellets obtained, comprising blowing agent, are expanded to give a molded foam.

The extrusion process can also be used to produce the foam directly, an example being XPS (expanded polystyrene). For this, the melt comprising blowing agent is produced as described in the extruder, but is extruded directly into the ambient atmosphere. In this process, the melt extrudate foams to give the finished foam, and is usually directly molded here to give a foam web, which is then chopped to give sheets.

EP-A 1 002 829 describes how particulate expandable styrene polymers (EPS) comprising solids are produced in suspension and in the presence of from 1 to 25% by weight of graphite particles, glass fibers, silicates, metal pigments, or metal oxides as solid.

The previous DE application No. 10358786.1, unpublished at the priority date of this application, describes foam moldings which are obtained via fusion of pre-foamed foam beads composed of expandable, filled polymer pellets. Among the polymers mentioned are styrene polymers, polyether sulfones and polyether ketones, and among the fillers mentioned are silicates, glass beads, zeolites, metal oxides, metal carbonates, metal hydroxides, metal sulfates, and glass fibers, the amounts of these being from 1 to 50% by weight. Production of the expandable pellets via extrusion with a blowing agent and under water pelletization is also described.

DE-A 42 07 057 describes a process for foaming of high-meltingpoint synthetic aromatic polymers, e.g. polyetherimides, polyether sulfones, etc., to give foam webs by the extrusion process, where the melt has to be cooled in a certain manner but still in the extruder, prior to the foaming process. Fillers are not mentioned.

EP-A 1 333 051 discloses a process for production of foam webs from a polysulfone or from a polyether sulfone via extrusion with a blowing agent, and extrusion into the ambient atmosphere. Fillers are not mentioned.

The previous DE application No. 10321787.8, unpublished at the priority date of the present invention, describes a process for production of foam sheets composed of styrene-acrylonitrile copolymers via extrusion with a blowing agent and with subsequent foaming. Fillers are mentioned only generally and without any statement of quantities.

WO 03/018678 gives a process for production of open-cell foam sheets via extrusion of a styrene polymer melt with a blowing agent. The only filler mentioned is carbon particles, e.g. graphite, the amounts of these being from 1 to 10% by weight, based on the styrene polymer.

The previous DE application No. 10307736.7, unpublished at the priority date of the present invention, describes a foam composed of a plastic resistant to high temperatures (polyetherimides, polysulfones, polyether ketones, inter alia) via extrusion with a blowing agent and extrusion into the ambient atmosphere. The desired open-cell nature of the foam can be achieved inter alia via addition of pulverulent solids, the amounts of these being from 0.1 to 5% by weight, based on the polymer composition. The only pulverulent solids mentioned are graphite or graphite together with talc or with other solids.

The compressive strength of the foam is of decisive importance for certain applications of foam sheets, for example in perimeter insulation (insulation in contact with soil, e.g. on the outer sides of basements), or if walking on the insulated surface is intended to be possible (e.g. inverted roofs, i.e. roofs with external insulation). Adequate compressive strength is also desired in foams resistant to high temperatures which have to resist pressure because the insulation serves simultaneously as protection from mechanical effects or as a housing. Examples of these applications are insulating sheets and, respectively, moldings obtainable therefrom used as insulation or housings of motors, of other machinery, or pipelines for hot fluids.

The compressive strengths of the foams of the prior are not always adequate for these applications.

Furthermore, the fire performance of the known foams is not ideal. By way of example, disadvantageous conditions can lead to production of high-density combustion gases and high-density smoke. High-density here means that the smoke comprises a large amount of suspended materials (solid particles or liquid particles) per unit of volume. However, low-density smoke would be advantageous for avoidance of injury to persons.

An object was to eliminate the disadvantages described, and in particular to provide a process which can produce foam webs and, respectively, foam sheets with improved compressive strength.

Furthermore, the foam sheets should exhibit improved fire performance. In particular, the density of the smoke produced should be lower (smaller amount of suspended materials per unit of volume). Ideally, the sheets should provide both properties, i.e. improved compressive strength and lower-density smoke.

Finally, the process should be capable of processing polymers as different as, on the one hand, plastics resistant to high temperatures, in particular polysulfones, polyetherimides, and polyether ketones, and on the other hand conventional styrene polymers, to give foam sheets with the advantageous properties mentioned.

Accordingly, the process defined at the outset has been found, as have the foam webs and, respectively, foam sheets obtainable thereby. Preferred embodiments of the invention are found in the subclaims.

The starting materials are described below. The foam webs and, respectively, foam sheets (hereinafter referred to by the abbreviated term sheets) are produced from a polymer selected from polysulfones, polyetherimides, polyether ketones, and styrene polymers.

Suitable polysulfones are any of the polymers whose repeat units have linking via sulfone groups —SO₂—, in particular polymers of the following general formulae 1 to 4:

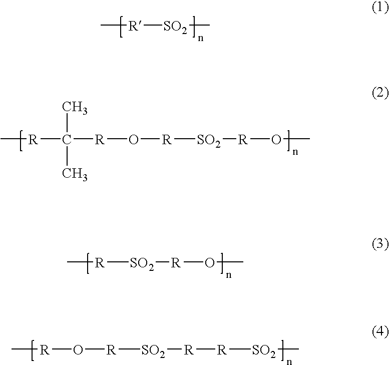

where R′ is alkyl or aryl, R is aryl, in particular phenyl, and n is the number of repeat units. Formula 2 shows the material specifically termed polysulfone (PSU). Among the suitable polysulfones are in particular the polyaryl sulfones, polyphenylene sulfones (PPSU), polyether sulfones (PES), and polyaryl ether sulfones. Formulae 3 and 4 illustrate polyaryl ether sulfones. All of these polysulfones are suitable.

The softening points of the polysulfones are generally about 180-230° C. Suitable polysulfones are known and are commercially available, for example in the form of Ultrason® S polysulfone from BASF, or Ultrason® E polyether sulfone from BASF.

Suitable polyetherimides (PEI) are polymers whose main chains are composed of aromatic rings linked by way of ether groups —O— and imide groups 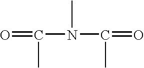
for example those of the formula 5 or 6

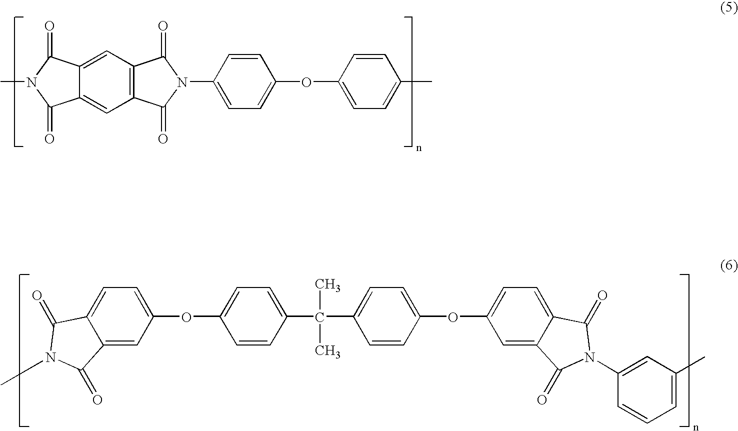

The softening points of the polyetherimides are generally about 200-230° C. Suitable polyetherimides are known and are commercially available, for example in the form of Ultem® from GE Plastics or Vespel® from DuPont.

Suitable polyether ketones are any of the polymers whose repeat units (phenylene radicals) have linkage by way of ether groups —O— and ketone groups —C=O. They have the formula 7 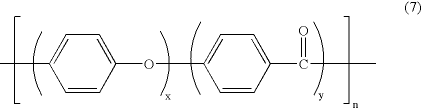
and are also termed polyaryl ether ketones (PAEK). Products where x=y=1 are specifically termed polyether ketones (PEK), those where x=2, y=1 are termed polyether ether ketones (PEEK), those where x=1, y=2 are termed polyether ketone ketones (PEKK), and those where x=y=2 are termed polyether ether ketone ketones (PEEKK). All of these polyether ketones are suitable.

The softening points of the polyether ketones are generally about 210-350° C. Suitable polyether ketones are known and are available commercially, for example in the form of Ultrapek®) from BASF.

Suitable styrene polymers are polymers of styrene compounds (vinylaromatic monomers), examples being styrene, α-methylstyrene, p-methylstyrene, ethylstyrene, tert-butylstyrene, vinylstyrene, vinyltoluene, 1,2-diphenylethylene, 1,1-diphenylethylene, and mixtures of these. It is particularly preferable to use styrene.

The styrene polymers can be homopolymers, for example (rubber-free) polystyrene (GPPS, general-purpose polystyrene), or copolymers. Examples of suitable comonomers present in these copolymers are nitrile compounds, such as acrylonitrile or methacrylonitrile; dienes, such as 1,3-butadiene (abbreviated to: butadiene), 1,3-pentadiene, 1,3-hexadiene, 2,3-dimethylbutadiene, isoprene, or piperylene; acrylates, in particular C₁₋₂-alkyl acrylates, such as n- or tert-butyl acrylate, or 2-ethylhexyl acrylate, and the corresponding methacrylates, such as methyl methacrylate (MMA). Other suitable comonomers are mentioned in DE-A 196 33 626 on page 3, lines 5-50, under M1-M10.

The usual amount of the comonomers is from 1 to 99% by weight, preferably from 5 to 95% by weight, and particularly preferably from 5 to 70% by weight, based on the styrene copolymer.

Particularly suitable comonomers are acrylonitrile, butadiene and n-butyl acrylate. A preferred styrene copolymer is impact-resistant polystyrene (HIPS, high-impact polystyrene). It usually comprises, as rubber phase, a butadiene rubber, dispersed in a hard matrix composed of styrene polymer, e.g. polystyrene. The butadiene rubber can, by way of example, be polybutadiene or a styrene-butadiene block copolymer, and the latter can, by way of example, be a two-block S-B copolymer, a three-block S-B-S copolymer or a multiblock copolymer, having a linear, grafted, or star-shaped structure (S=styrene block, B=butadiene block). Styrene-butadiene block copolymers are also suitable per se, as styrene copolymer i.e. without any hard styrene matrix.

Another preferred styrene copolymer is styrene-acrylonitrile copolymer (SAN). The usual acrylonitrile content is from 5 to 50% by weight, preferably from 10 to 40% by weight, and particularly preferably from 20 to 35% by weight, based on the SAN.

Other preferred styrene copolymers are acrylonitrile-butadiene-styrene copolymer (ABS), acrylonitrile-styrene acrylate copolymer (ASA), and acrylonitrile-EP(D)M-styrene copolymer (AES). Preferred ABS copolymers comprise, as rubber phase, a butadiene rubber, preferably butadiene, dispersed in a hard matrix composed of styrene-acrylonitrile copolymer. The rubber has usually been grafted with styrene and acrylonitrile, in order to improve the linkage of the rubber phase to the hard matrix. The structure of the preferred copolymers ASA and AES is analogous; ASA comprises, instead of the butadiene rubber, an acrylate rubber, for example composed of n-butyl acrylate. In the case of AES, a rubber composed of EPM (ethylene-propylene-monomer) or composed of EPDM (ethylene-propylene-diene monomer) is used.

In one preferred embodiment of the process, the styrene polymers have been selected from rubber-free polystyrene, impact-resistant polystyrene, styrene-acrylonitrile copolymer (SAN), acrylonitrile-butadiene-styrene copolymer (ABS), and acrylonitrile-styrene-acrylate copolymer (ASA).

The styrene polymers mentioned are known and are commercially available, for example in the form of Polystyrol®, Luran® (SAN), Terluran® (ABS), and Luran® S (ASA), all from BASF.

Suitable blowing agents are the usual inert gases, such as carbon dioxide (CO₂), nitrogen, or argon; water; aliphatic C₃-C₆ hydrocarbons, such as propane, butane, pentane or hexane (in each case any of the isomers, e.g. n- or iso-); aliphatic alcohols or aliphatic ketones whose boiling point is from 56 to 100° C., for example methanol, ethanol, propanol, isoproanol, butanol, acetone or methyl ethyl ketone (2-butanone); aliphatic esters, such as methyl or ethyl acetate; halogenated, in particular fluorinated, hydrocarbons, such as 1,1,1,2-tetrafluoroethane (R 134a) or 1,1-difluoroethane (R 152a); or chemical blowing agents, such as azo or diazo compounds, which liberate gases on the heating. In many cases, blowing agent mixtures which comprise two or more of the abovementioned blowing agents are particularly suitable.

It is particularly preferable to use halogen-free blowing agents, in particular water, CO₂, iso-butane, acetone, and ethanol. For sheets based on polysulfones, on polyetherimides, or on polyether ketones it is very particularly preferable here to use a blowing agent mixture composed of water and acetone, and for sheets based on styrene, it is very particularly preferable here to use a mixture composed of water and CO_{2.}

An advantage in the use of mixtures composed of water and another blowing agent is that the amounts used of liquids which are readily combustible at high temperatures such as those required for foaming of the polysulfones, polyetherimides or polyether ketones, are only very small, and the level of safety risk is thus lowered.

The amount of blowing agent depends on the desired density of the foam sheets. The amounts of the blowing agent generally added to the polymer melt are from 0.1 to 15% by weight, preferably from 3 to 12% by weight, based on the polymer and calculated as the entirety of all of the blowing agents.

The inventive process can make concomitant use of a nucleating agent, in order to control the number of cells in the foam. Nucleating agents cause production of a large number of pores at the start of the foaming process, and contribute to production of a fine and uniform pore structure. A wide variety of added materials can serve here as nucleating agents, examples being fine-particle solids which do not melt under the conditions of the process, e.g. silica gel, talc, chalk, phyllosilicates, metal carbonates and metal hydrogen carbonates, carbon black, graphite, boron nitride, azo compounds, silicas, such as Aerosil® from Degussa, aluminum nitride, aluminum silicates, calcium sulfate, mica, nanoparticles composed, for example, of glass, and wollastonite.

Solid additions which per se serve as flame retardants for improvement of fire resistance, e.g. zinc borate, can also. serve as nucleating agents, as also can the abovementioned inert gases, such as nitrogen or noble gases. The latter can be incorporated by mixing into the polymer melt under high pressure (e.g. 60 to 250 bar absolute). Other suitable nucleating agents are chemical blowing agents (their amounts preferably being small), such as sodium hydrogen carbonate and citric acid, available commercially by way of example in the form of Hydrocerol® CF from Clariant.

If use is made of a nucleating agent, the amount is usually from 0.01 to 2% by weight, based on the polymer.

According to the invention, the melt comprises from 1 to 50% by weight, based on the polymer, of a filler selected from a fibrous filler A, a particulate, non-graphite filler B, and mixtures of the fillers A and B.

Suitable fibrous fillers A are any of the fibers which do not melt at the temperatures prevailing in the polymer melt. Organic fibers are suitable, e.g. fibers composed of flax, hemp, ramie, jute, sisal, cotton, cellulose or aramid, and inorganic fibers are also—preferably suitable, in particular carbon fibers, glass fibers, and fibrous silicates, such as wollastonite or asbestos.

It is particularly preferable to use glass fibers as fibrous filler A. They may by way of example be used in the form of short glass fibers or else in the form of glass textiles, glass mats, or glass silk rovings (continuous-filament strands). The glass textiles, glass mats, or glass rovings are, if necessary, comminuted prior to incorporation by mixing into the polymer melt. Chopped glass can also be used.

The fibrous fillers, in particular the glass fibers, may have been equipped with a size and/or with a coupling agent, or hydrophobicized, in order to improve compatibility with the polymer.

The average fiber length of the fibrous filler A is preferably from 0.1 to 10 mm and in particular from 1 to 4 mm prior to the mixing with the polymer. The average fiber diameter of the fibrous filler A is from 2 to 40 μm, in particular from 5 to 25 μm prior to the mixing with the polymer.

The ratio of average fiber length to average fiber diameter is preferably from 5000:1 to 4:1, in particular from 100:1 to 10:1 prior to the mixing with the polymer.

The fiber lengths and fiber diameters mentioned can change as a result of incorporation of the filler into the polymer, and the lengths and diameters stated above are therefore those prior to the mixing with the polymer. By way of example, the shear forces occurring in the extruder can comminute or agglomerate the filler. This also applies to the particulate filler B described at a later stage below, and its particle diameter.

According to the invention, the amount of the fibrous filler A is from 1 to 50% by weight, preferably from 2 to 40% by weight, and particularly preferably from 5 to 20% by weight, based on the polymer used.

Suitable particulate fillers B are any of the particles which do not melt at the temperatures prevailing in the polymer melt. The particles can, by way of example, be spherical or lamellar, or have an irregular shape. They can be “solid” or can have atomic-scale or macroscopic-scale inner cavities, examples being zeolites or hollow beads.

Examples of suitable particulate fillers B are naturally occurring or synthetic calcium carbonates (e.g. chalk, dolomite); magnesium carbonates; alkaline earth metal sulfates, such as calcium sulfate or barium sulfate (baryte); silicates, such as glass beads or glass powders, talc, kaolin, mica (e.g. muscovite), feldspars, such as nepheline, zeolites, bentonites, smectites, wollastonite, asbestos, or other silicates of aluminum, of calcium, or of magnesium; powder quartz, and also naturally occurring and synthetic silicas, in particular fumed silicas, e.g. Aerosil® from Degussa; metal oxides, such as aluminum oxide (alumina) or zirconium oxide; metal hydroxides, such as aluminum hydroxide or magnesium hydroxide; metal nitrides, such as aluminum nitride; metal flakes or metal lamellae, e.g. composed of aluminum or bronze, silicon carbide; and aluminum diboride. According to the invention, graphite is excluded as particulate filler.

The particulate filler B has preferably been selected from calcium carbonate, calcium sulfate, and talc.

The average particle diameter of the particulate filler B is preferably from 0.1 to 1000 μm, particularly preferably from 0.2 to 300 μm, prior to the mixing with the polymer. In the case of non-spherical particles, e.g. lamellae, particle diameter means the greatest linear dimension.

In the case of lamellar or laminar particles, e.g. talc, the aspect ratio (diameter of lamella/thickness of lamella) is usually from 1000:1 to 1:1, in particular from 100:1 to 2:1 prior to the mixing with the polymer. In the case of non-lamellar particles, this aspect ratio means the ratio of greatest to smallest linear dimension.

According to the invention, the amount of the particulate filler B is from 1 to 50% by weight, preferably from 2 to 40% by weight, and particularly preferably from 5 to 30% by weight, based on the polymer used.

Another suitable filler is low-melting-point glass. By way of example, this is an alkali zinc phosphate glass whose glass transition temperature is about 275° C., for example the glass obtainable commercially in the form of Cortem™ from Corning. As a function of whether the low-melting-point glass is used in the form of fibers or of particles, it is counted with the fibrous fillers A and, respectively, with the particulate fillers B.

The amount of filler A and, respectively, B required in a particular case depends inter alia on the desired mechanical properties of the foam sheet, for example on the desired compressive strength, and on the fire performance, e.g. the maximum specified smoke density in the event of fire, and can be determined via preliminary experiments.

As a function of the type and amount of filler used, it is also possible to use coupling agents, such as maleic-anhydride-modified styrene copolymers, polymers comprising epoxy groups, organosilanes, or styrene copolymers having isocyanate groups or having acid groups. These coupling agents can improve linkage of the filler to the polymer matrix and thus improve the mechanical properties of the foam sheets.

In the production of the foam sheets, concomitant use can also be made of conventional additives (added materials and processing aids), the amounts of these additives being those conventional for these substances, and examples being lubricants or mold-release agents, colorants, e.g. pigments or dyes, flame retardants, antioxidants, light stabilizers, and antistatic agents, and also other additives, or a mixture of these.

It is, of course, also possible to use mixtures of the starting materials mentioned—polymers, blowing agents, nucleating agents, fillers, coupling agents, additives, etc. In this case, the amounts stated above are based on the entirety of the respective starting materials.

Following the starting materials, the process will now be described. The inventive process extrudes a melt which comprises the polymer, comprises the blowing agent, and, according to the invention, comprises the filler A and/or B. The polymer is usually introduced in the form of solid, e.g. in the form of pellets or powder, into an extruder, and the polymer is melted in the extruder, but it is also possible to prepare a polymer melt in advance and to introduce this into the extruder.

The blowing agent is also metered into the extruder—mostly at superatmospheric pressure. It is preferably fed into the polymer melt, but another possibility is that it is added to the solid polymer, and that the extruder melts the polymer. In each case, a substantially homogeneous mixture of polymer and blowing agent is produced.

The filler is also introduced into the extruder. In the extruder it is uniformly mixed with the melt, but is usually not melted, the result therefore being a melt which comprises blowing agent and has filler fibers and, respectively, filler particles dispersed therein. (However, if the low-melting-point glass mentioned is used as filler, the glass can, as a function of extruder temperature, assume plastic properties or melt, and the foam produced on cooling and foaming of this type of melt can, by way of example, have a mutually interpenetrating polymer phase and glass phase.)

By way of example, the filler can be introduced undiluted directly into the extruder, by direct metering into the extruder, or the polymer and the filler can be used in advance to prepare a mixture (blend), which is then added to the extruder. Certain mixtures of this type of polymer and filler are commercially available in the form of what are known as reinforced or filled polymer blends, and this type of commercially available blend can be used if it has the desired content of filler.

If the latter is not the case, the desired filler content of the foam sheet can be established via mixing of appropriate quantitative proportions of two polymers and, respectively, polymer blends, where the first polymer is intended to comprise a smaller amount of filler than the desired foam sheet, and the second polymer is intended to comprise more. By way of example, a filler-free polymer I can be mixed with a filled polymer II. By way of example, sheets whose filler content is 10% by weight can be produced via mixing of equal amounts of a filler-free polymer I and of a polymer II comprising 20% by weight of filler. The polymers can be mixed in advance or their mixing can be delayed until they are within the extruder, meaning that the two polymers are introduced separately into the extruder, where they are mixed.

Accordingly, one preferred embodiment of the process is an embodiment wherein a mixture composed of two polymers I and II is used as polymer, where the polymer I comprises no filler, and the polymer II comprises the fibrous filler A, or comprises the particulate filler B, or comprises a mixture of these.

Other added materials, such as the abovementioned nucleating agents, coupling agents, or additives, are likewise introduced into the extruder or are by this stage present in the polymer used.

Extruders that can be used are conventional single- or twin-screw extruders. The temperature, pressures, and other operating conditions along the extruder here are selected conventionally in such a way that firstly the polymer is melted and uniformly mixed with the blowing agent and the filler, and secondly the melt retains sufficient viscosity at the end of the extruder to form a good foam during the subsequent foaming process. The screw rotation rate and screw geometry (number of flights, pitch, flight depth, etc.) should be selected in such a way that the resultant shear forces do not comminute or agglomerate the filler fibers or filler particles, or comminute or agglomerate them only to the desired extent. This applies in particular to fibrous fillers A, whose fiber length usually decreases, from a few mm prior to the mixing process to a few 100 μm in the resultant polymer foam.

It is preferable to use what is known as a tandem system, composed of two extruders. In the first extruder, known as a compounding extruder, the polymer is first melted at a temperature above its softening point, and the filler is metered in, and the blowing agent is injected into the melt and mixed. In the second extruder, known as a cooling extruder, the mixture is cooled to a temperature at which the viscosity of the melt ensures production of a good foam.

The polymer melt comprising blowing agent and filler is then foamed. This takes place in a conventional manner via extrusion of the melt from the extruder, ambient pressure and ambient temperature outside of the extruder being adjusted here in such a way that the blowing agent expands and the melt foams, with solidification. Ambient pressure and ambient temperature during the foaming process depend in a known manner inter alia on the desired density of the foam sheets, on the nature of the polymer, and also on the nature and amount of the blowing agent. By way of example, material may be extruded and foamed into the ambient atmosphere at room temperature (23° C.).

The foaming process generally uses an appropriately shaped die plate, e.g. a slot die, followed by what is known as a calibrator. This method directly gives a foam web, which is drawn off continuously. The calibrator can adjust the thickness and width of the web, which is then divided into sheets.

The thickness of the resultant foam sheets is usually from 5 to 1000 mm, in particular from 10 to 500 mm, and their width is generally from 100 to 2000 mm, preferably from 200 to 1500 mm, and their cross-sectional area is usually from 10 to 20 000 cm², in particular from 20 to 7500 cm².

The density of the resultant foam sheets, determined to DIN EN 826, is preferably from 15 to 200 g/l, particularly preferably from 20 to 120 g/l.

The level of fine-cell and open-cell character of the foam sheet is generally increased via the addition of filler. The level of open-cell character can be varied via the selection of the blowing agent, of the density of the foam, and of the process parameters, and in most cases the given polymer can be used to produce either open-cell foams or closed-cell foams. Examples of the process parameters varied are temperature and pressure in the extruder and the geometry of the die through which the extruder contents are extruded.

The foam is generally a closed-cell foam, meaning that discrete gas cells are present in the foam, and the open-cell factor of the foam, determined to DIN EN ISO 4590, is at most 40%, preferably at most 20%, and particularly preferably at most 10%. However, it is also possible to produce foams with higher open-cell factor via suitable process conditions.

The size of the gas cells, determined via measurement of the cells under an optical microscope, is generally from 5 to 1000 μm, preferably from 50 to 500 μm.

The compressive strength of the sheets naturally depends on the polymer used. In the case of sheets composed of polysulfones, of polyetherimides, or of polyether ketones, it is preferably from 0.05 to 3 N/mm², in particular from 0.2 to 2 N/mm², and in the case of sheets composed of styrene polymers it is preferably from 0.1 to 2 N/mm², in particular from 0.15 to 1 N/mm², determined at 23° C. to ISO 844.

The invention also provides the foam webs and, respectively, foam sheets obtainable by the inventive process, in particular those whose density, determined to DIN EN 826, is from 15 to 200 g/l.

The inventive sheets can, as a function of the polymer used, be used in many different ways, e.g. as cores for sandwich elements, as buoyancy, for example for watercraft, and for soundproofing or, respectively, thermal insulation of buildings, of machinery, or of vehicles.

The foam sheets obtained by the inventive process feature improved compressive strength. Furthermore, they have improved fire performance, and in particular the density of smoke generated is lower, when comparison is respectively made with sheets obtained by processes of the prior art.

Surprisingly, the inventive process is equally suitable for polymers as different as, on the one hand, polysulfones, polyetherimides, and polyether ketones, i.e. plastics resistant to high temperatures, and conventional styrene polymers on the other hand.

### EXAMPLES

The following starting materials were used:

PES: an unfilled polyether sulfone; the commercially available product Ultrason® E 2010 from BASF was used,
PES-G: a polyether sulfone comprising 20% by weight of glass fibers whose average fiber length in the polymer was 200 μm and whose average fiber diameter was 15 μm; the commercially available product Ultrason® E 2010 G4 from BASF was used,
SAN: an unfilled styrene-acrylonitrile copolymer; the commercially available product Luran® 378 P from BASF was used,
SAN-G: a styrene-acrylonitrile copolymer comprising 35% by weight of glass fibers whose average fiber length in the polymer was 200 μm and whose average fiber diameter was 15 μm; the commercially available product Luran® 378 P G7 from BASF was used,
chalk: a naturally occurring calcium carbonate (98% of particles <3 μm, 82% <1 μm); the commercially available product Hydrocarb® OG from Omya was used,
talc: talc whose average particle diameter D₅₀ was 1.5 μm; the commercially available product Micro-Talc IT Extra from Mondo Minerals Oy was used.

A tandem system was used, composed of a compounding extruder and of a downstream cooling extruder. The polymer or the polymer mixture (see table) was continuously introduced to the compounding extruder together with the nucleating agent talc and, respectively, the filler chalk. The blowing agents (water, acetone, and, respectively, CO₂, see table) were introduced continuously via an inlet aperture on the compounding extruder. The polymer melt comprising blowing agent was cooled in the cooling extruder to the foaming temperature (see table) and extruded via a slot die. The foaming melt was molded in a calibrator to give foam sheets of the thickness and, respectively, width mentioned in the table.

The density of the sheets was determined to DIN EN 826, and the compressive strength of the sheets was determined to ISO 844, at 23° C.

The table collates the starting materials, foaming temperatures, and results. C means comparative example and Pt. means parts, and acet. means acetone. The quantitative data in % by weight for the starting materials are based on the polymer melt.

TABLE
Foam sheets (C means comparative example, Pt. means parts, and acet. means acetone)

| Example | | | | | |
|---|---|---|---|---|---|
| 1C | 2 | 3C | 4 | 5C | 6 |

| | | |
|---|---|---|
| Polyether sulfone/ | Styrene-acrylonitrile- | Polyether sulfone/ |
| glass fiber | Copo./glass fiber | chalk |

Starting materials and foaming temperature

| | | | | | | |
|---|---|---|---|---|---|---|
| Polymer [Pts. by wt.] | 100 PES | 50 PES | 100 SAN | 70 SAN | 100 PES | 90 PES |
| | | 50 PES-G | | 30 SAN-G | | 10 chalk²⁾ |
| Talc [% by weight]¹⁾ | 0.1 | 0.1 | 0.2 | 0.2 | 1 | — |
| Blowing agent [% by wt.¹⁾ | 0.8 H₂O | 1.0 H₂O | 1.1 H₂O | 1.3 H₂O | 3.0 H₂O | 1.0 H₂O |
| | 3.0 acet. | 3.0 acet. | 4.2 CO₂ | 4.2 CO₂ | | 3.0 acet. |
| Foaming temp. [° C.] | 233.5 | 233.9 | 128.3 | 129.3 | 230.6 | 224.4 |

Properties of sheets

| | | | | | | |
|---|---|---|---|---|---|---|
| Thickness × width [mm] | 20 × 250 | 20 × 250 | 50 × 150 | 43 × 150 | 20 × 180 | 20 × 200 |
| Filler content [% by wt.] | 0 | 10 | 0 | 10.5 | 0 | 10 |
| Density [g/l] | 52.9 | 53.1 | 32.3 | 32.7 | 82.1 | 81.3 |
| Compressive strength [N/mm²] | 0.32 | 0.41 | 0.24 | 0.32 | 0.95 | 1.12 |

¹⁾based on the polymer melt
²⁾as filler

The examples show that the foam sheets composed of PES and comprising glass fiber (example 2) produced by the inventive process have markedly higher compressive strength when compared with the non-inventive unfilled PES sheets (example 1C), at comparable density. The same principle applies to the sheets composed of SAN with and without glass fiber (examples 4 and 3C). Again, use of chalk as particulate filler gave higher compressive strength of the PES sheets at comparable density. than for PES sheets without chalk (examples 6 and 5C). Surprisingly, the process was suitable not only for PES but also for SAN, and not only for fibrous fillers but also for particulate fillers.

1-12. (canceled)

13. A process for the production of a foam web or a foam sheet, wherein the foam web or form sheet comprises a polymer selected from the group consisting of polysulfones, polyetherimides, polyether ketones, and styrene-acrylonitrile copolymer (SAN), acrylonitrile-butadiene-styrene copolymer (ABS), and acrylonitrile-styrene-acrylate copolymer (ASA), and mixtures thereof comprising extruding a melt which comprises the polymer and a blowing agent, and then foaming of the melt,
which comprises the additional presence in the melt of from 5 to 50% by weight, based on the polymer, of a filler selected from
A) a fibrous filler A,
B) at least one particulate filler B selected from the group consisting of calcium carbonate, calcium sulfate, magnesium carbonate, barium sulfate, mica, zeolites and silicates,
or a mixture of A) and B).

14. The process according to claim 13, wherein the styrene-acrylonitrile copolymer has acrylonitrile content of from 20 to 35% by weight.

15. The process according to claim 13, wherein glass fibers are used as fibrous filler A.

16. The process according to claim 13, wherein when the filler A is used, the average fiber length of the fibrous filler A is from 0.1 to 10 nm prior to the mixing with the polymer.

17. The process according to claim 13, wherein when filler A is used, the average fiber diameter of the fibrous filler A is from 2 to 40 μm prior to the mixing with the polymer.

18. The process according to claim 13, wherein the melt comprises from 0.01 to 2% by weight of talc, based on the polymer, as nucleating agent.

19. The process according to claim 13, wherein when filler B is used, the average particle diameter of the particulate filler B is from 0.1 to 1000 μm prior to the mixing with the polymer.

20. The process according to claim 13, wherein the amount of blowing agent is from 0.1 to 15% by weight, based on the polymer.

21. The process according to claim 13, wherein a mixture composed of two polymers I and II is used as polymer, where the polymer I comprises no filler, and the polymer II comprises the fibrous filler A or the particulate filler B, or a mixture of fibrous filler A and particulate filler B.

22. The process according to claim 13, wherein the blowing agent is selected from the group consisting of water, CO₂, acetone, ethanol and mixtures thereof.

23. A foam web or a foam sheet, the web or sheet being obtainable by the process according to claim 13.

24. A foam web or a foam sheet according to claim 23, whose density, determined to DIN EN 826, is from 15 to 200 g/l.
